(19) United States
(12) Patent Application Publication
(10) Pub. No.: US 2006/0051530 A1
(43) Pub. Date: Mar. 9, 2006

(54) Coating for a microporous printing sheet having improved peel strength

(76) Inventors: Richard A. Schwarz, Akron, OH (US); Suryya K. Das, Pittsburgh, PA (US); Charles T. Hill, New Brighton, PA (US); Soner Kilic, Bilkent (TR); Luciano M. Parrinello, Allison Park, PA (US)

Correspondence Address: PPG Industries, Inc.;Law-Intellectual Property 39S, One PPG Place, Pittsburgh, PA, 15272, US

(21) Appl. No.: 10/937,523

(22) Filed: Sep. 9, 2004

(51) Int. Cl. B41M 5/00

(52) U.S. Cl. 428/32.24

(57) ABSTRACT

Coatings for microporous printing sheets are disclosed. The coatings comprise an acrylic resin and a dye fixative material. The coated microporous sheets may be inkjet printed with good image characteristics. The printed sheets may be laminated, and possess high peel strengths while maintaining favorable optical characteristics. The coated microporous printing sheets are useful for many applications such as laminated security cards, tags and labels, as well as wide format printing applications.

The present invention is directed to a microporous printing sheet. In particular, the invention relates to a coating for a microporous printing sheet. The coated sheet can be useful in many products such as but not limited to laminated security cards, tags, labels and other specialty and commercial printing applications.

Microporous sheets generally comprise a thermoplastic organic polymer, particulate filler and pores. The sheets can be printed by various techniques known in the art, such as but not limited to digital offset printing and thermal transfer printing. A non-limiting example of a microporous printing sheet comprises polyethylene and silica filler particles sold under the trade name Teslin® printing sheet by PPG Industries, Incorporated.

Microporous printing sheets are useful in many applications such as but not limited to cards, tags, labels, menus and print graphics. A non-limiting application includes laminated security cards, such as photo identification cards, which can be laminated to protect against tampering. One characteristic of laminated cards is peel strength. It is desirable for the bond between the outer lamination layer and the underlying printed microporous sheet to be such that the outer layer cannot be removed without at least partially damaging or destroying the printed image on the microporous sheet. To further prevent tampering, it is desirable for laminated security cards to retain sufficient peel strength following a soak in water for an extended period of time.

Another characteristic of microporous printing sheets can be the ability to accept high quality printed images produced by various printing techniques known in the art, including but not limited to inkjet printing. Further, if the printed sheets are subsequently laminated, it is desirable for the printed image to retain good optical characteristics such as but not limited to high color density and definition.

Accordingly, there is a need for a microporous printing sheet which can be inkjet printed with good image characteristics and laminated, and wherein the laminated sheet can possess good peel strength and optical characteristics.

The present invention is directed to a coating composition for a microporous printing sheet wherein the coating can comprise an acrylic resin and a dye fixative material.

Another aspect of the present invention is to provide a method of making a coating composition for a microporous printing sheet. The method can comprise synthesizing an acrylic copolymer from hydroxyalkyl(meth)acrylates and poly(alkylene glycol) (meth)acrylates or C₁-C₄ alkoxypoly(alkylene glycol)(meth)acrylates, and mixing the acrylic copolymer with a dye fixative material.

A further aspect of the present invention is to provide a microporous printing sheet which can comprise a layer of microporous material, and a coating on at least a portion of the layer of microporous material wherein the coating can comprise an acrylic resin and a dye fixative material.

Another aspect of the present invention is to provide a method of coating a microporous printing sheet. The method can comprise providing a layer of microporous material, and at least partially coating the layer of microporous material with a composition which can comprise an acrylic resin and a dye fixative material.

A further aspect of the present invention is to provide a laminated printed microporous sheet. The laminated sheet can comprise a printed microporous sheet having a coating wherein the coating can comprise an acrylic resin and a dye fixative material, and a lamination layer covering at least a portion of the printed microporous sheet.

Another aspect of the present invention is to provide a method of making a laminated printed microporous sheet. The method can comprise providing a microporous sheet, at least partially coating the microporous sheet with a composition comprising an acrylic resin and a dye fixative material, and applying a lamination layer over at least a portion of the printed sheet.

A further aspect of the present invention is to provide an inkjet printed essentially tamper-resistant security card which can comprise an inkjet printed microporous sheet and a lamination layer covering at least a portion of the inkjet printed microporous sheet. In a non-limiting embodiment, the card can have an initial peel strength of at least 10 lb/inch and a 24-hour peel strength of at least 5 lb/inch.

For the purposes of this specification, unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

These and other aspects of the present invention will be more apparent from the following description.

The present invention includes a coating for a microporous printing sheet. The coated sheet can be printed by various methods known in the art including but not limited to inkjet printing. The printed coated sheet can be laminated using a variety of conventional techniques known in the art. The coated microporous sheet can have good image quality such as high color density, definition and smear resistance. Following lamination, the printed microporous sheet can retain good image quality and the laminated sheet can have good peel strength.

As used herein, the term “microporous printing sheet” refers to a substrate that can be printed by various conventional techniques known in the art such as but not limited to inkjet printing to produce an image, such as but not limited to text, graphics, photos, bar codes, patch codes and the like. In a non-limiting embodiment, the microporous printing sheet comprises a polymer, filler particles and pores. In a further non-limiting embodiment, the microporous printing sheet can comprise substantially water-insoluble thermoplastic organic polymer. A variety of such polymers suitable for use in the present invention are known to one having ordinary skill in the art. In general, any substantially water-insoluble thermoplastic organic polymer which can be extruded, calendared, pressed or rolled into film, sheet, strip or web can be used. In alternate non-limiting embodiments, the polymer can be a single polymer or it can be a mixture of polymers. Non-limiting examples of suitable polymers can include homopolymers, copolymers, random copolymers, block copolymers, graft copolymers, atactic polymers, isotactic polymers, syndiotactic polymers, linear polymers or branched polymers. In alternate non-limiting embodiments, a mixture of polymers can be used wherein the mixture can be homogeneous or it can comprise two or more polymeric phases.

Non-limiting examples of suitable substantially water-insoluble thermoplastic organic polymers can include but are not limited to thermoplastic polyolefins, poly(halo-substituted olefins), polyesters, polyamides, polyurethanes, polyureas, poly(vinyl halides), poly(vinylidene halides), polystyrenes, poly(vinyl esters), polycarbonates, polyethers, polysulfides, polyimides, polysilanes, polysiloxanes, polycaprolactones, polyacrylates, and polymethacrylates.

In a non-limiting embodiment, hybrid classes can be used in the present invention. Hybrid classes can include but are not limited to thermoplastic poly(urethane-ureas), poly(ester-amides), poly(silane-siloxanes), and poly(ether-ester). Non-limiting examples of suitable substantially water-insoluble thermoplastic organic polymers can include thermoplastic high density polyethylene, low density polyethylene, ultrahigh molecular weight polyethylene, polypropylene (atactic, isotactic, or syndiotactic), poly(vinyl chloride), polytetrafluoroethylene, copolymers of ethylene and acrylic acid, copolymers of ethylene and methacrylic acid, poly(vinylidene chloride), copolymers of vinylidene chloride and vinyl acetate, copolymers of vinylidene chloride and vinyl chloride, copolymers of ethylene and propylene, copolymers of ethylene and butene, poly(vinyl acetate), polystyrene, poly(omega-aminoundecanoic acid), poly(hexamethylene adipamide), poly(epsilon-caprolactam) and poly(methyl methacrylate).

In a non-limiting embodiment, the microporous printing sheet can comprise substantially water-insoluble particulate filler. A wide variety of such fillers suitable for use in the present invention are known in the art, and can include but are not limited to siliceous and/or non-siliceous particles. In a further non-limiting embodiment, the particulate filler can be finely divided substantially water-insoluble siliceous particles. As used herein and the claims, the term “finely divided” refers to a maximum retention of 0.01% by weight on a 40-mesh sieve screen. Non-limiting examples of suitable siliceous particles can include but are not limited to particles of silica, mica, montmorillonite, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. In alternate non-limiting embodiments, precipitated silica, silica gel or fumed silica can be used.

Non-limiting examples of non-siliceous filler particles can include but are not limited to particles of titanium oxide, zinc oxide, antimony oxide, zirconia, magnesia, alumina, zinc sulfide, barium sulfate, strontium sulfate, calcium carbonate, magnesium carbonate, magnesium hydroxide, and finely divided substantially water-insoluble flame retardant filler particles such as particles of ethylenebis(tetra-bromophthalimide), octabromodiphenyl oxide, decabromodiphenyl oxide, and ethylenebisdibromonorbornane dicarboximide.

The particle size of the filler particles can vary. In a non-limiting embodiment, the filler particles can have an average particle size of less than 40 micrometers. In a further non-limiting embodiment, the filler particles can include precipitated silica having an average ultimate particle size (irrespective of whether or not the ultimate particles are agglomerated) of less than 0.1 micrometer. The particle size can be determined by a variety of conventional techniques. In the present invention, the filler was stirred for ten (10) minutes in Isoton II electrolyte solution (Curtin Matheson Scientific, Inc.) using a four-blade, 4.445-centimeter diameter propeller stirrer, and then the particle size of the filler was determined using a Model TaII Coulter Multisizer Particle Size Analyzer (Coulter Electronics, Inc.).

In alternate non-limiting embodiments, the filler particles can be in the form of ultimate particles, aggregates of ultimate particles, or a combination of both. As used herein and in the claims, the term “ultimate particles” refers to small discrete particles of colloidal polymerized silicic acid units which make up amorphous silica.

In another non-limiting embodiment, the microporous printing sheet can include other known conventional materials used in processing. Non-limiting examples of such materials can include but are not limited to lubricant, processing plasticizer, organic extraction liquid, and water. The amount of these materials can vary widely. In a non-limiting embodiment, these materials can be present in minor amounts, such as but not limited to less than 5% by weight of the microporous printing sheet.

In a further non-limiting embodiment, the microporous printing sheet can include materials such as but not limited to antioxidants, ultraviolet light absorbers, reinforcing fibers such as but not limited to chopped glass fiber strand. These materials can be present in varying amounts. In a non-limiting embodiment, these materials can be present in an amount of less than 15% by weight of the microporous printing sheet.

In a non-limiting embodiment, the microporous printing sheet of the present invention can comprise pores. The volume of pores present in the microporous material can vary. In alternate non-limiting embodiments, the pores can constitute on a coating-free and printing ink-free basis at least 35 percent or at least 60 percent, and not more than 75 percent or not more than 95 percent by volume of the microporous printing sheet. Further, the size of the pores can vary. In alternate non-limiting embodiments, the volume average diameter of the pores on a coating-free and printing ink-free basis can be at least 0.02 micrometers, or at least 0.04 micrometers, or less than 0.5 micrometers.

Non-limiting examples of suitable microporous printing sheets for use in the present invention are known in the art and can include but are not limited to the printing sheets described in U.S. Pat. Nos. 4,833,172; 4,861,644; and 6,114,023; wherein such relevant disclosure is incorporated herein by reference. Commercially available microporous printing sheets suitable for use in the present invention can be obtained under the trade name Teslin® printing sheet by PPG Industries, Incorporated.

As used herein and the claims, the term “coating” refers to a material that can be at least partially applied to at least a portion of a microporous printing sheet. The coating can form at least a portion of a surface layer on the microporous sheet and/or can penetrate at least partially into at least a portion of the pores of the microporous sheet. In a non-limiting embodiment, the coating can at least partially penetrate into the sheet. In a further non-limiting embodiment, the coating can essentially entirely penetrate into the sheet. In another non-limiting embodiment, the coating does not completely fill the pores of the microporous printing sheet, such that the pore structure can be maintained throughout at least a portion of the sheet. In still another non-limiting embodiment, the molecules of the coating can comprise an end that can essentially electrostatically link with a polar end of a printing dye, and another end that can at least partially attach to the polymer and/or particulate filler of the microporous printing sheet.

In a non-limiting embodiment, the coating composition of the present invention can comprise an acrylic resin and a dye fixative material. The amount of the acrylic resin and dye fixative material can vary. In a non-limiting embodiment, the weight ratio of acrylic resin to dye fixative material can be from 1:1 to 100:1 or from 2:1 to 50:1. In another non-limiting embodiment, the coating composition can comprise water. The amount of water can vary. In alternate non-limiting embodiments, the coating composition can include from 50% to 99% water by weight, or from 60% to 97% water by weight.

In a non-limiting embodiment, the acrylic resin can include a copolymer. As used herein, the term “copolymer” refers to a polymeric material made from two or more monomers. Suitable copolymers for use in the present invention are varied and known. In a non-limiting embodiment, the copolymer can include hydroxyalkyl(meth)acrylate. In a further non-limiting embodiment, the copolymer can include a vinyl comonomer. Suitable vinyl comonomers for use in the present invention can include but are not limited to poly(alkylene glycol) (meth)acrylates or C₁-C₄ alkoxy poly(alkylene glycol)(meth)acrylates (MPEG MA). Non-limiting examples of hydroxyalkyl(meth)acrylate can include but are not limited to hydroxyethyl acrylate (HEA), hydroxyethyl methacrylate, hydroxypropyl acrylate and/or hydroxypropyl methacrylate. In a non-limiting embodiment, HEA can be used. In alternate non-limiting embodiments of the present invention, the poly(alkylene glycol)(meth)acrylate can comprise MPEG 350 MA, MPEG 550 MA and/or MPEG 2000 MA, wherein the numbers 350, 550 and 2000 represent the approximate molecular weights of the compositions.

The weight ratio of the components of the copolymer can vary and can depend upon the selection of monomer components. For example, in a non-limiting embodiment, the weight ratio of HE to MPEG MA can be from 1:100 to 100:1, or from 1:1 to 50:1, or 10:1 to 20:1.

In a non-limiting embodiment, the acrylic resin can be synthesized from vinyl monomers, at least 50 percent by weight of which can be 2-hyroxyethyl acrylate. In a further non-limiting embodiment, the vinyl monomers can comprise at least one other vinyl comonomer. The proportion of the 2-hydroyethyl acrylate and the other vinyl comonomer or comonomers can vary, with the provision that the proportion of each monomer utilized can be adapted to provide a resultant hydroxyl functional acrylic polymer which can be capable of forming a stable dispersion in water without an externally added surfactant. Thus, in this embodiment, depending on the selection of comonomer in the vinyl monomer component, the amount of 2-hydroxyethyl acrylate can be more than 50 weight percent, provided the resultant polymer exhibits dispersibility in water. The comonomer which is utilized in conjunction with the 2-hydroxyethyl acrylate can be selected from a wide variety of vinyl monomers. Non-limiting examples of suitable vinyl monomers can include but are not limited to n-butyl methacrylate, methyl methacrylate and n-butyl acrylate. In a non-limiting embodiment, MPEG MA can be used.

In a non-limiting embodiment, the acid value and the proportion of each monomer used in the synthesis of the acrylic copolymer can be adapted to form a stable dispersion in water. In a further non-limiting embodiment, the proportion of 2-hydroxyethyl acrylate can be 50 percent, the acid value of the resultant polymer can be at the higher end of the acid value range of from at least 1.5 to not greater than 10. In a non-limiting embodiment, the proportion of 2-hydroxyethyl acrylate can be higher than 50 percent, and the acid value of the polymer can be at the lower end of the range.

In alternate non-limiting embodiments, the hydroxyl functional acrylic polymer can have a number average molecular weight of at leasst 500, or at least 1000 and less than 4500, or less than 2000.

The acrylic copolymer can be prepared by a variety of methods known to one having ordinary skill in the art. In a non-limiting embodiment, the acrylic copolymer can be prepared by free-radical initiated solution polymerization in the presence of a free-radical initiator and an organic solvent. The organic solvent can be selected from a wide variety of known materials. Non-limiting examples of suitable organic solvents can include primarily non-polar solvents such as but not limited to xylene, isopropyl benzene, high boiling ketones such as but not limited to isobutyl ketone, and high boiling esters such as but not limited to hexyl acetate.

In a non-limiting embodiment, the amount of co-polymer such as 2-hydroxyethyl acrylate can be above 50 weight percent, and a polar solvent such as isopropanol can be used to facilitate stable dispersion of the resultant hydroxyl functional acrylic polymer in water. In a further non-limiting embodiment, 60 percent or more of 2-hydroxyethyl acrylate can be used, and isopropanol can be employed during the polymerization of the acrylic polymer to facilitate the subsequent dispersion into water because the polymer is soluble in isopropanol. In a further non-limiting embodiment, the solvent used during synthesis can be selected such that the resultant polymer can be substantially soluble. If the resultant polymer is substantially insoluble, phase separation and precipitation of the polymer can occur.

The polymerization can be carried out at various temperatures. In alternate non-limiting embodiments, the temperature can be at least 60° C., or at least 80° C. and less than 200° C., or less than 150° C.

The acrylic copolymer can be prepared by other methods known in the art. In another non-limiting embodiment, the acrylic copolymer can be prepared by solution polymerization in the organic solvent, followed by neutralization, the addition of water, and removal of the organic solvent by azeotropic distillation.

In a non-limiting embodiment of the present invention, the dye fixative material can comprise at least one cationic nitrogen-containing polymer wherein at least a portion of the nitrogen atoms carry at least a portion of a cationic charge at the pH of the coating composition. Non-limiting examples of nitrogen-containing monomers or resulting monomer residues suitable for use in the present invention can include but are not limited to dimethyl aminoethyl (meth)acrylate, (methyl)acryloyloxyethyl trimethyl ammonium halides, (meth)acryloyloxyethyl trimethyl ammonium methylsulfate, dimethyl aminopropyl(meth)acrylamide, (meth)acrylamidopropyl trimethyl ammonium halides, aminoalkyl(meth)acrylamides where the amine can be reacted with epichlorohydrin, (meth)acrylamidopropyl trimethyl ammonium methylsulfate, diallyl amine, methyl diallyl amine, and diallyl dimethyl ammonium halides.

In a non-limiting embodiment, the dye fixative material can be part of an aqueous solution. The amount of dye fixative present in solution can vary. In a further non-limiting embodiment, the amount of dye fixative can be at least one (1) weight percent, or at least 5 weight percent, and not more than 45 weight percent, or not more than 50 weight percent, based on the weight of the solution.

In a non-limiting embodiment, the nitrogen-containing polymers can contain additional monomer residues. The additional monomer residues can be from essentially any polymerizable ethylenically unsaturated monomer that, when copolymerized with the nitrogen containing monomers, allows the resulting polymer to be at least partially soluble in water. In a non-limiting embodiment, at least 0.1 gram of the polymer can dissolve in water when 10 grams of the polymer is added to 1 liter of water and mixed for at least 24 hours.

In alternate non-limiting embodiments, the nitrogen-containing polymers of the dye fixative material can be homopolymers of a nitrogen-containing monomer or copolymers of one or more nitrogen-containing monomers, or copolymers of one or more polymerizable ethylenically unsaturated monomers and one or more nitrogen-containing monomers. In a further non-limiting embodiment, the nitrogen-containing dye fixative material can comprise a reaction product of polyamide amines and epichlorohydrin and/or a polymer of diallyl dimethyl ammonium chloride. In another non-limiting embodiment, the dye fixative material can comprise a reaction polymer of epihalohydrin and dialkylamine such as but not limited to epichlorohydrin and dimethylamine, respectively. In another embodiment, the dye fixative material can comprise a reaction polymer of dialkyldiallylamine such as but not limited to dimethyldiallylamine. A commercially available dye fixative material suitable for use in the present invention is a solution of polyamide amines reacted with epichlorohydrin, under the trade name CinFix by Stockhausen GmbH & Co. KG.

In a non-limiting embodiment, the coating composition of the present invention can be used to at least partially coat a microporous printing sheet. The coating composition can be at least partially applied to the sheet using a variety of standard coating methods known in the art such as but not limited to Meyer rod, air knife and/or lexographic techniques. The thickness of the coating can vary. In alternate non-limiting embodiments, the coating can be at least partially applied on the sheet with a coverage of from 0.001 to 50 g/m², or from 0.01 to 10 g/m², or from 0.1 to 1 g/m².

In a non-limiting embodiment, at least a portion of the coating can remain on the surface of the microporous sheet following the coating operation. In another non-limiting embodiment, the coating can at least partially penetrate into at least a portion of the pores of the sheet. In alternate non-limiting embodiments, the at least partially coated sheet can have a porosity of from 30 to 90 volume percent, or from 50 to 80 volume percent.

In another non-limiting embodiment, the coated microporous printing sheet can be printed using standard inkjet printing techniques known in the art. The term “inkjet printing” as used herein and the claims, refers to its standard meaning and includes printing processes in which images are created by deposition of patterns. In a non-limiting embodiment, an image can be created in a thermal inkjet printing process by successive deposition of black, cyan, magenta and yellow colored inks in a dot pattern.

In a non-limiting embodiment, the printed image can have good optical density. The optical density can vary. As used herein and the claims, optical density represents reflectance or transmittance characteristics for a particular wavelength, and can be computed according to the formula D=log₁₀(1/T) or D=log₁₀ (1/R), wherein D represents optical density, T represents transmittance, and R represents reflectance. In a non-limiting embodiment, the optical density of a printed article can be based on the colors cyan, magenta and yellow. In another non-limiting embodiment, the optical density can be based on cyan, magenta, yellow, composite black and pigment black. In a further non-limiting embodiment, the printed microporous sheet can have an optical density of at least 1.0 for each of the colors cyan, magenta and yellow. In another non-limiting embodiment, the printed sheet can have an optical density of at least 1.0 for composite black and/or pigment black. In a non-limiting embodiment, these optical densities can be maintained after the inkjet printed sheet has been laminated.

In a non-limiting embodiment of the present invention, the at least partially coated microporous printing sheet can have favorable initial peel strength and favorable 24-hour peel strength after inkjet printing. The term “initial peel strength” means the initial force required to separate a lamination layer from the adjacent printed substrate of the laminate. Initial peel strength can be measured by a variety of techniques known in the art. In a non-limiting embodiment, it can be measured in accordance with ANSI INCITS 322, Test Method 5.1, Delamination—180 degrees. The pull test is conducted at 180 degrees within 15 minutes of lamination. The initial peel strength can vary. In alternate non-limiting embodiments, the initial peel strength can be at least 3.2 lb/inch, or at least 5 lb/inch, or at least 10 lb/inch.

As used herein and the claims, the term “24-hour peel strength” means the force required to separate the lamination layer from the adjacent printed substrate following a 24-hour water soak, and can be measured by a variety of techniques known in the art. The 24-hour peel strength was measured in accordance with ANSI INCITS 322, Test Method 5.1, Delamination—180 degrees, with the exception that instead of testing a dry sample, the samples were soaked in tap water, dried for a period of time such as but not limited to one-hour, and then pull-tested. The 24-hour peel strength can vary. In alternate non-limiting embodiments, the coated microporous printing sheet can have a 24-hour peel strength of at least 3.2 lb/inch, or at least 5 lb/inch.

In a non-limiting embodiment, the present invention can include a laminated printed microporous sheet. The sheet can include a printed microporous sheet, at least partially coated with an acrylic resin and dye fixative composition, and a lamination layer covering at least a portion of the printed microporous sheet. In a non-limiting embodiment, the microporous sheet can be at least partially coated, and the coated sheet can be at least partially laminated. The lamination layer can comprise a variety of materials known in the art. In a non-limiting embodiment, the lamination layer can comprise materials such as but not limited to polyester, polypropylene, polyvinylcarbonate and/or nylon. In another non-limiting embodiment, the lamination layer can comprise an adhesive at least partially bonded to the printed microporous sheet. Non-limiting examples of suitable adhesives can include but are not limited to ethylene vinyl acetate and polyesters.

The lamination layer can be at least partially applied over at least a portion of the printed microporous sheet by standard techniques known in the art, such as but not limited to platen press or roll lamination. The thickness of the lamination layer can vary. In a non-limiting embodiment, the lamination layer can have a thickness of from 0.5 to 10 mils.

In a non-limiting embodiment of the present invention, an essentially tamper-resistant security card can be produced. The card can include a lamination layer covering at least a portion of the inkjet printed microporous sheet. After lamination, the edges of the card can be die cut by standard techniques known in the art. In a non-limiting embodiment, the edges of the die cut security card can be exposed to the environment, and high initial peel strength and high 24-hour peel strength can be maintained. In a non-limiting embodiment, the initial peel strength of the security card can be at least 10 lb/inch and the 24-hour peel strength can be at least 5 lb/inch.

The following examples are intended to illustrate aspects of the present invention, and are not intended to limit the scope of the invention.

### EXAMPLES

### Example 1

An acrylic resin for a coating composition was made using the charges listed in Table 1.

TABLE 1

| Ingredients | Charge Number | Parts by Weight |
|---|---|---|
| | Charge #1 | |
| Isopropyl Alcohol | | 260 |
| | Charge #2 | |
| 2-Hydroxyethyl | | 475 |
| Acrylate (HEA) | | |
| MPEG 350 MA | | 25.0 |
| 2,2′-Azobis | | 15.0 |
| (2-methylbutyronitrile) | | |
| (Vazo-67) | | |
| Isopropyl Alcohol | | 8.5 |
| | Charge #3 | |
| DI Water | | 835 |

Charge #1 was added to a 2-liter 3-necked flask equipped with a motor-driven stainless steel stir blade, water-cooled condenser and a heating mantle with a thermometer connected through a temperature feed-back control device. The contents of the flask were heated to reflux (82° C.). Charge #2 was premixed and added to the reaction flask over a period of 3 hours while maintaining a temperature of 82° C. After the addition of Charge #2 was complete, the mixture continued stirring at 82° C. for two (2) additional hours. Upon completion of the 2-hour hold, the solvent was removed by distillation. Once viscosity of the mixture begin to build, Charge #3 was added until a total of 835 grams of distillate had been removed yielding approximately 780 grams of resin at 60% solids.

### Example 2

A copolymer of 90% HEA with 10% MPEG 550 MA made in a similar manner as described in Example 1 was diluted to 10 wt. % solids and 90 parts of the diluted copolymer was blended with 10 parts of 25 wt. % CinFix NF dye fixative compound. The resulting coating composition was found to be stable over a period of 96 hours at room temperature.

### Example 3

Coating compositions made in accordance with Example 2 were applied to Teslin® microporous sheets by a Meyer rod technique as follows. A sheet of 8.5 inch×11 inch, 10 mil thick, Teslin® microporous sheet was placed on a 15 inch×20 inch×20 mil backing sheet. A metering bar was placed 1-2 inches above the microporous sheet, parallel to the top edge. A 10-20 ml quantity of coating was drawn into a disposable plastic syringe. The coating was deposited as a bead strip approximately ⅛ inch wide directly next to and touching the metering bar. The bar was drawn completely across the microporous sheet at a substantially constant rate. The resultant wet sheet was placed in a forced air oven, secured and dried at 95° C. for 2 minutes.

### Example 4

A coating composition made in accordance with Example 2 was applied to a Teslin® microporous sheet by a flexographic technique as follows. A line consisting of two coating stations, each with a forced air drying oven, was used. Each coating station consisted of a coating feed chamber, anilox roll and rubber application roll. The coating feed chamber was supplied from a coating holding tank and pump. A line speed of 180 fpm and an oven temperature of 105° C. (220° F.) was used. Four passes per roll were made, which translates into four passes per surface. Both sides of the microporous sheet were coated. The coating compositions were applied with an approximate coat weight of 0.73 g/m² (total front and back).

### Example 5

Coated microporous printing sheets made in accordance with Example 3 were printed using a Hewlett Packard HP970 desktop inkjet printer. Portions of the images containing solid areas of cyan, magenta, yellow, composite black and pigment black (C, M, Y, CMY and K) were laminated with a 2.33 mil thick sheet of laminating film sold under the designation TransKote® in a standard pocket laminator. Specimens 1 inch wide were cut from the laminate to give successive blocks of color along the length of the specimen. The initial peel strength was measured for each of the colored regions in accordance with ANSI INCITS 322, Test Method 5.1, Delamination—180 degrees. The 24-hour peel strengths were measured for each of the colored regions in accordance with ANSI INCITS 322, Test Method 5.1, Delamination—180 degrees, with the exception that the samples were soaked in tap water and dried prior to conducting the pull tests. The results of the 24-hour peel strength tests are shown in Tables 2 and 3. Table 2 compares different lengths of time between lamination and water soak. Table 3 compares drying conditions.

TABLE 2
Laminated Card 24-Hour Peel Strengths

| | Time Delta | | | | | | |
|---|---|---|---|---|---|---|---|
| | Between | | Lamination Peel Strength | | | | |
| | Lamination | | following 24 hr Water | | | | |
| Sample | and Water | | Soak (lb/in) | | | | |
| ID | Soak | | CMY | C | M | Y | K |
| 1 | 1-18 | hours | 0 | 0.63 | 7.37 | 3.24 | 0 |
| 1 | 72 | hours | 4.40 | 6.49 | 22.32 | 17.82 | 4.13 |
| 2 | 1-18 | hours | 0 | 0 | 8.26 | 4.06 | 1.59 |
| 2 | 72 | hours | 9.07 | 6.55 | 23.89 | 20.27 | 5.49 |
| 3 | 1-18 | hours | 2.08 | 3.20 | 13.11 | 10.57 | 3.29 |
| 3 | 72 | hours | 7.84 | 8.07 | 22.41 | 19.05 | 5.53 |

Drying conditions = 95° C. for 2 minutes.
Time delta between coating and printing = 24 hours.
Time delta between printing and laminiation = 10 minutes.

TABLE 3
Laminated Card 24-Hour Peel Strengths

| | | Lamination Peel Strength | | | | |
|---|---|---|---|---|---|---|
| | Drying | following 24 hr Water Soak | | | | |
| Sample | Condition | (lb/in) | | | | |
| ID | Temp/Time | CMY | C | M | Y | K |
| 2 | 95° C./2 | 3.36 | 10.41 | 21.99 | 15.76 | 5.71 |
| | minutes | | | | | |
| 2 | 95° C./2 | 6.44 | 12.66 | 21.01 | 14.68 | 9.40 |
| | minutes | | | | | |
| 2 | 95° C./15 | 10.58 | 19.57 | 23.64 | 23.13 | 13.48 |
| | minutes | | | | | |
| 2 | 95° C./15 | 14.67 | 19.77 | 23.78 | 23.49 | 16.54 |
| | minutes | | | | | |
| 2 | 105° C./8 | 19.75 | 21.31 | 24.13 | 24.12 | 15.14 |
| | minutes | | | | | |
| 2 | 105° C./8 | 14.03 | 17.38 | 22.17 | 21.18 | 12.87 |
| | minutes | | | | | |
| 2 | 115° C./2 | 4.082 | 10.14 | 17.94 | 17.00 | 10.54 |
| | minutes | | | | | |
| 2 | 115° C./2 | 10.22 | 14.60 | 19.08 | 17.27 | 11.55 |
| | minutes | | | | | |
| 2 | 115° C./15 | 9.21 | 13.69 | 19.81 | 15.51 | 11.63 |
| | minutes | | | | | |
| 2 | 115° C./15 | 7.36 | 11.85 | 14.85 | 13.62 | 10.51 |
| | minutes | | | | | |

Time delta between coating and printing = 24 hours.
Time delta between printing and laminiation = 10 minutes.
Time delta between lamination and water soak = 18 hours.

As shown in Tables 2 and 3, coated microporous printing sheets of the present invention possess very good 24-hour peel strengths for the colors cyan (C), magenta (M) and yellow (Y), as well as composite black (CMY) and pigment black (K). Optical density measurements were made on pre-laminated cards and laminated cards similar to those listed in Tables 2 and 3. The optical density results are shown in Tables 4 and 5.

TABLE 4
Pre-lamination Optical Density Values

| | Drying | | | | | |
|---|---|---|---|---|---|---|
| Sample | Condition | Optical Density | | | | |
| ID | Temp/Time | CMY | C | M | Y | K |
| 2 | 95° C./2 | 0.99 | 1.14 | 1.05 | 0.87 | 0.97 |
| | minutes | | | | | |
| 2 | 95° C./15 | 1.00 | 1.15 | 1.06 | 0.90 | 0.99 |
| | minutes | | | | | |
| 2 | 105° C./8 | 1.01 | 1.15 | 1.05 | 0.90 | 0.98 |
| | minutes | | | | | |
| 2 | 115° C./2 | 0.98 | 1.13 | 1.02 | 0.91 | 0.98 |
| | minutes | | | | | |
| 2 | 115° C./15 | 0.96 | 1.13 | 0.99 | 0.86 | 0.96 |
| | minutes | | | | | |

TABLE 5
Laminated Optical Density Values

| Sam- | Lamination Peel | | | | | | | | | |
|---|---|---|---|---|---|---|---|---|---|---|
| ple | Strength, lb/in | | | | | Optical Density | | | | |
| ID | CMY | C | M | Y | K | CMY | C | M | Y | K |
| 4 | 3.7 | 6.9 | 19.8 | 13.6 | 2.4 | 1.13 | 1.05 | 1.21 | 1.03 | 1.13 |

As shown in Table 5, the cyan (C), magenta (M) and yellow (Y) optical densities of the laminated cards are all above 1.0. The composite black (CMY) and pigment black (K) optical densities are also above 1.0.

Whereas particular embodiments of this invention have been described above for purposes of illustration, it will be evident to those skilled in the art that numerous variations of the details of the present invention may be made without departing from the invention as defined in the appended claims.

What is claimed is:

1. A coating composition for a microporous printing sheet comprising:
an acrylic resin; and
a dye fixative material.

2. The coating composition of claim 1, wherein the weight ratio of the acrylic resin to the dye fixative material is from 1:1 to 100:1.

3. The coating composition of claim 1, wherein the weight ratio of the acrylic resin to the dye fixative material is from 2:1 to 50:1.

4. The coating composition of claim 1, wherein the composition comprises from 50 to 99 weight percent water.

5. The coating composition of claim 1, wherein the composition comprises from 60 to 97 weight percent water.

6. The coating composition of claim 1, wherein the acrylic resin comprises a copolymer.

7. The coating composition of claim 6, wherein the copolymer comprises hydroxyalkyl (meth)acrylate and poly(alkylene glycol) (meth)acrylate.

8. The coating composition of claim 7, wherein the hydroxyalkyl (meth)acrylate comprises hydroxyethyl acrylate.

9. The coating composition of claim 1, wherein the acrylic resin comprises hydroxyalkyl (meth)acrylate.

10. The coating composition of claim 1, wherein the acrylic resin comprises poly(alkylene glycol) (meth)acrylate.

11. The coating composition of claim 1, wherein the acrylic resin comprises hydroxyalkyl (meth)acrylate and poly(alkylene glycol) (meth)acrylate.

12. The coating composition of claim 11, wherein the weight ratio of hydroxyalkyl (meth)acrylate to poly(alkylene glycol) (meth)acrylate is from 1:100 to 100:1.

13. The coating composition of claim 11, wherein the weight ratio of hydroxyalkyl (meth)acrylate to poly(alkylene glycol) (meth)acrylate is from 1:1 to 50:1.

14. The coating composition of claim 11, wherein the weight ratio of hydroxyalkyl (meth)acrylate to poly(alkylene glycol) (meth)acrylate is 10:1.

15. The coating composition of claim 1, wherein the dye fixative material comprises a cationic nitrogen-containing polymer.

16. The coating composition of claim 1, wherein the dye fixative material comprises dimethyl aminoethyl (meth)acrylate, (meth)acryloyloxyethyl trimethyl ammonium halides, (meth)acryloyloxyethyl trimethyl ammonium methylsulfate, dimethyl aminopropyl (meth)acrylamide, (meth)acrylamidopropyl trimethyl ammonium halides, aminoalkyl (meth)acrylamides where the amine is reacted with epichlorohydrin, (meth)acrylamidopropyl trimethyl ammonium methylsulfate, diallyl amine, methyl diallyl amine and/or diallyl dimethyl ammonium halides.

17. The coating composition of claim 1, wherein the dye fixative material comprises a reaction polymer of epihalohydrin and dialkylamine or a reaction polymer of dialkyldiallylamine.

18. The coating composition of claim 1 wherein the Acrylic resin forms a substantially stable dispersion in water.

19. A method of making a coating composition for microporous printing sheets, the method comprising:
synthesizing an acrylic copolymer from hydroxyalkyl (meth)acrylate and poly(alkylene glycol) (meth)acrylate; and mixing the copolymer with a dye fixative material.

20. The method of claim 19, wherein the hydroxyalkyl (meth)acrylate comprises hydroxyethyl acrylate and the dye fixative material comprises a cationic nitrogen-containing polymer.

21. The method of claim 19, wherein the weight ratio of the hydroxyalkyl (meth)acrylate to poly(alkylene glycol) (meth)acrylate is from 1:100 to 100:1.

22. The method of claim 21, wherein the weight ratio of the acrylic copolymer to the dye fixative material is from 1:1 to 100:1.

23. A microporous printing sheet comprising:
a layer of microporous material; and
a coating on the layer of microporous material comprising an acrylic resin and a dye fixative material.

24. The microporous printing sheet of claim 23, wherein the microporous material comprises polyethylene.

25. The microporous printing sheet of claim 24, wherein the microporous material further comprises silica filler particles.

26. The microporous printing sheet of claim 23, wherein the printing sheet has a porosity of from 50 to 80 volume percent.

27. The microporous printing sheet of claim 23, wherein the coating has coverage of from 0.01 to 10 grams per square meter of the printing sheet.

28. The microporous printing sheet of claim 23, wherein the acrylic resin comprises a copolymer including hydroxyalkyl (meth)acrylates and poly(alkylene glycol) (meth)acrylates, and the dye fixative material comprises a cationic nitrogen-containing polymer.

29. The microporous printing sheet of claim 23, wherein the printing sheet has an initial peel strength of at least 3.2 lb/inch.

30. The microporous printing sheet of claim 23, wherein the printing sheet has a 24-hour peel strength of at least 3.2 lb/inch.

31. The microporous printing sheet of claim 23, wherein the printing sheet is capable of being inkjet printed with an optical density of at least 1.0 for each of the colors cyan, magenta and yellow.

32. The microporous printing sheet of claim 31, wherein the printing sheet is further capable of being inkjet printed with an optical density of at least 1.0 for composite black.

33. The microporous printing sheet of claim 31, wherein the printing sheet is further capable of being inkjet printed with an optical density of at least 1.0 for pigment black.

34. The microporous printing sheet of claim 31, wherein the printing sheet retains an optical density of at least 1.0 for each of the colors cyan, magenta and yellow after the inkjet printed sheet has been laminated.

35. The microporous printing sheet of claim 34, wherein the printing sheet has an initial peel strength of at least 3.2 lb/inch.

36. The microporous printing sheet of claim 34, wherein the printing sheet has a 24-hour peel strength of at least 3.2 lb/inch.

37. A method of coating a microporous printing sheet comprising:
providing a layer of microporous material; and
coating the layer of microporous material with a composition comprising an acrylic resin and a dye fixative material.

38. The method of claim 37, wherein the coating is applied with a coverage of from 0.01 to 10 grams per square meter of the sheet.

39. The method of claim 38, wherein the coating step includes Meyer rod coating.

40. The method of claim 38, wherein the coating step includes flexographic coating.

41. The method of claim 38, wherein the acrylic resin comprises a copolymer including hydroxyalkyl (meth)acrylates and poly(alkylene glycol) (meth)acrylates, and the dye fixative material comprises a cationic nitrogen-containing polymer.

42. The method of claim 38, wherein the coated microporous printing sheet has an initial peel strength of at least 3.2 lb/inch.

43. The method of claim 38, wherein the coated microporous printing sheet has an 24-hour peel strength of at least 3.2 lb/inch.

44. A laminated printed microporous sheet comprising:
a printed microporous sheet having a coating comprising an acrylic resin and a dye fixative material; and
a lamination layer covering at least a portion of the printed microporous sheet.

45. The laminated printed microporous sheet of claim 44, wherein the microporous sheet comprises polyethylene and silica filler particles.

46. The laminated printed microporous sheet of claim 44, wherein the acrylic resin comprises a copolymer including hydroxyalkyl (meth)acrylates and poly(alkylene glycol) (meth)acrylates, and the dye fixative material comprises a cationic nitrogen-containing polymer.

47. The laminated printed microporous sheet of claim 46, wherein the lamination layer comprises polyester, polypropylene, polyvinylcarbonate and/or nylon, and has a thickness of from 0.5 to 10 mils.

48. The laminated printed microporous sheet of claim 47, wherein the lamination layer further comprises an adhesive adjacent to the printed microporous sheet.

49. The laminated printed microporous sheet of claim 46, wherein the sheet has an initial peel strength of at least 3.2 lb/inch.

50. The laminated printed microporous sheet of claim 46, wherein the sheet has a 24 hour peel strength of at least 3.2 lb/inch.

51. The laminated printed microporous sheet of claim 46, wherein the printed microporous sheet is inkjet printed.

52. The laminated printed microporous sheet of claim 51, wherein the laminated inkjet printed sheet has an optical density of at least 1.0 for each of the colors cyan, magenta and yellow.

53. The laminated printed microporous sheet of claim 52, wherein the laminated inkjet printed sheet has an optical density of at least 1.0 for composite black or pigment black.

54. A method of making a laminated printed microporous sheet comprising:
providing a microporous sheet;
coating the microporous sheet with a composition comprising an acrylic resin and a dye fixative material; and
applying a lamination layer over at least a portion of the printed sheet.

55. The method of claim 54, wherein the printing step comprises inkjet printing.

56. The method of claim 55, wherein the laminated inkjet printed sheet has an optical density of at least 1.0 for each of the colors cyan, magenta and yellow.

57. The method of claim 56, wherein the laminated inkjet printed sheet has an optical density of at least 1.0 for composite black or pigment black.

58. The method of claim 55, wherein the sheet has an initial peel strength of at least 3.2 lb/inch.

59. The method of claim 55, wherein the sheet has a 24-hour peel strength of at least 3.2 lb/inch.

60. An inkjet printed essentially tamper-resistant security card comprising:
an inkjet printed microporous sheet; and
a lamination layer covering at least a portion of the inkjet printed microporous sheet, wherein the card has an initial peel strength of at least 10 lb/inch and a 24-hour peel strength of at least 5 lb/inch.

61. The inkjet printed essentially tamper-resistant security card of claim 60, wherein the inkjet printed portion of the card has an optical density of at least 1.0 for each of the colors cyan, magenta and yellow.

62. The inkjet printed essentially tamper-resistant security card of claim 61, wherein the inkjet printed portion of the card has an optical density of at least 1.0 for composite black or pigment black.

63. The inkjet printed essentially tamper-resistant security card of claim 60, wherein the card has die cut edges.

64. The inkjet printed essentially tamper-resistant security card of claim 60, wherein the microporous sheet includes a coating comprising an acrylic resin and a dye fixative material.
